(19) United States
(12) Patent Application Publication
(10) Pub. No.: US 2009/0018687 A1
(43) Pub. Date: Jan. 15, 2009

(54) PRODUCTION INSTRUCTION SYSTEM AND PRODUCTION INSTRUCTION METHOD

(76) Inventors: Hisaya Ishibashi, Yokohama (JP); Youichi Nonaka, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/166,650

(22) Filed: Jul. 2, 2008

(30) Foreign Application Priority Data
Jul. 9, 2007 (JP) 2007-179194

(51) Int. Cl. G06F 19/00; G06F 17/10

(52) U.S. Cl. 700/103; 703/2

(57) ABSTRACT

To create production instructions in a short period of time, in the presence of a divergence between a planned production number and the number of performance generated by variations of production volume due to variations of yield with respect to production lines of electronic device products such as a hard disk and a liquid crystal display, a product ratio of input volume to a production line (product mix) is changed by calculating the average number of performance and a standard deviation in an arbitrary period from the divergence between the planned number of production and the number of performance at the present and the production performance in the past; calculating a target achievement probability to a final target from the average number of performance, the standard deviation and the production performance at present; and comparing the target achievement probability to the final target with a threshold.

### CLAIM OF PRIORITY

The present application claims priority from Japanese application serial no. JP2007-179194, filed on Jul. 9, 2007, the content of which is hereby incorporated by reference into this application.

### BACKGROUND OF THE INVENTION

1. Field of the Invention

The invention relates to a production instruction system and a production instruction method creating production instructions having a high rate of strictly observing delivery time in a short period of time in production instruction operation of products in which a characteristic value of individual product does not satisfy a standard value aimed in design and completion volume is liable to fluctuate due to instability of production processes.

2. Description of Related Art

A production process of high-tech device products such as a hard disk and a liquid crystal display generally includes a parts forming process which requires microfabrication such as a thin-film process or polishing and an assembly process assembling completed parts into products. For example, concerning the hard disk, a magnetic head or a disk as primary parts are fabricated in different parts forming processes and plural magnetic heads or disks are assembled in the assembly process with other parts such as a spindle motor and a frame to complete products through a test process.

In related arts, there is a method of observing delivery time by instructing workers to perform production in consideration of divergence of actual performance with respect to completion requirement volume, priority of respective products, a load status of equipment and the like. For example, in JP-A-5-12298, there is a method of observing delivery time by grasping a lot arriving from a post-process equipment group to a present process equipment group to shorten lead time of a lot whose work priority is high. Further, for example, in JP-A-7-129672, there is a method of observing delivery time by a work instruction which allows actual work progress to follow target warehousing volume. On the other hand, in JP-A-10-161708, there is a method of observing delivery time by making good use of production capacity of the whole line by controlling start of work in respective equipment groups so as to satisfy buffer capacity constraints, making use of equipment capacity in a continuous process equipment group and planning a work start schedule based on an individual lot attribute.

There is also a method of observing delivery time by allocating customers according to standards or applications of products based on characteristics test results of products in the production process. Concerning an intermediate stock customer allocation system, for example, there are JP-A-11-353393 and JP-A-11-345750.

However, in the case of high-tech devices such as the hard disk and the liquid crystal display, there may be a case in which a characteristic value of each product does not satisfy a standard value which is aimed in design and a product will have another standard value whose characteristic value is in a rank lower than the original standard value, or the product may be defective due to instability of production processes. As a result, there arises a problem that the completion volume of the product fluctuates and diverges from a production plan to adversely affect the strict observance of delivery time for customers.

In the above related arts, such instability of production processes is not considered and it is difficult to provide production instructions for strictly observing delivery time for customers. As a result, there arises a problem that the delay of delivery time for customers occurs.

### SUMMARY OF THE INVENTION

In view of the above problem, an object of the invention is to provide a production instruction system and a production instruction method providing production instructions in real time, in which variations of characteristic values and yield variations are calculated.

In order to solve the above problems, the present invention proposes a product instruction system which creates production instructions of a product in which a characteristic value of each product is liable to vary from a standard value aimed in design due to instability of production processes, including an information collection unit collecting performance information of results selected as a product in accordance with design when each product satisfies an original design standard value, selected as other products having different standard values when each product does not satisfy the original design standard value, or selected as detective products when each product does not satisfy any standard value according to measured characteristic values by measuring characteristic values of each inputted product in a test process in plural production processes, a statistical work calculation unit calculating the average number of performance and a standard deviation in an arbitrary period by using the collected performance information, a target achievement probability calculation unit calculating a target achievement probability to a final target in production performance at present time in accordance with information obtained from the information collection unit and the statistical work calculation unit, a production instruction change determination unit fixing the change of product mixes of all products, determining production instruction change by comparing the target achievement probability to the final target calculated in the target achievement probability calculation unit with a threshold set in advance, and repeating processing of changing the product mix until the target achievement probability becomes the threshold or more, and a production instruction creation unit creating production instructions based on the product mix information fixed by the production instruction change determination unit and production plan information, as well as a production instruction method executed by the system.

According to the invention, the divergence between the number of plans and the number of performance generated from variations of production volume due to variations of yield is prevented to the minimum, thereby creating production instructions for strictly observing delivery time for customers in a short period of time. The divergence between the number of plans and the number of performance is prevented to the minimum, thereby achieving improvement of the strict observation rate of delivery time and reduction of products in-process in the production line.

### BRIEF DESCRIPTION OF THE DRAWINGS

FIG. 1 is a block diagram showing a process flow of a production line to be a subject of the invention;

FIG. 2 is a block diagram showing a production configuration to be targets of the invention;

FIG. 3 is a block diagram showing a hardware configuration according to an embodiment of the invention;

FIG. 4 is a block diagram showing an external storage device according to an embodiment of the invention;

FIG. 5 is a block diagram showing a configuration diagram of a processing program according to an embodiment of the invention;

FIG. 6 is a chart showing an operation flow concerning a production instruction system according to an embodiment of the invention;

FIG. 7 is a chart showing input plan information according to an embodiment of the invention;

FIG. 8 is a chart showing yield information according to an embodiment of the invention;

FIG. 9 is chart showing completion requirement volume information according to an embodiment of the invention;

FIG. 10 is a chart showing production performance information according to an embodiment of the invention;

FIG. 11 is a chart showing production performance aggregation information according to an embodiment of the invention;

FIG. 12 is a chart showing a processing flow of the production performance collection according to an embodiment of the invention;

FIG. 13 is a chart showing a processing flow executing evaluation of a target achievement probability according to an embodiment of the invention;

FIG. 14 is a chart showing priority information according to an embodiment of the invention; and

FIG. 15 is a block diagram explaining preconditions in a test process according to an embodiment of the invention.

### DETAILED DESCRIPTION OF THE PREFERRED EMBODIMENTS

Hereinafter, an embodiment of the invention will be explained.

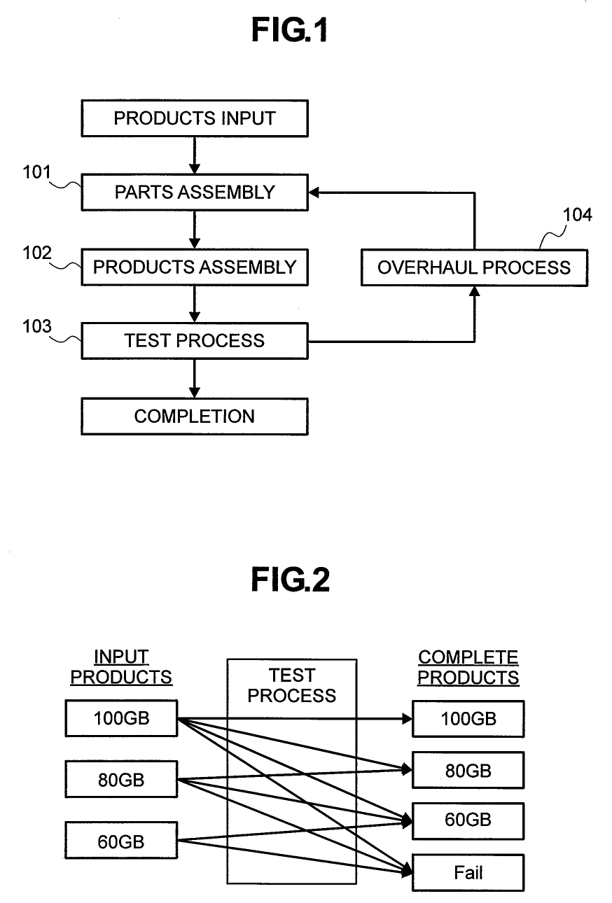

FIG. 1 shows an example of a production process according to an embodiment of the invention. As the embodiment of the invention, the production process of a hard disk will be explained. The production process of the hard disk to be a subject of the invention includes a parts assembly process (101) in which plural magnetic heads as a primary part are stacked to make intermediate parts, a products assembly process (102) in which the intermediate parts are assembled to casings with parts such as a disk, a spindle motor, a frame, a circuit substrate and the like, a test process (103) in which final quality check is performed and an overhaul process (104) in which products which were defective in the test process are overhauled to be returned to the parts assembly process as parts.

FIG. 2 explains test results in the test process (103) with respect to the product to be the subject in this case. The hard disks passed through the products assembly process (102) are allocated to some products through some kinds of tests such as a read/write test or a resistance test in the test process (103). For example, products inputted into the test process originally at 100 gigabyte are allocated to 100 gigabyte products, 80 gigabyte products, 60 gigabyte products and defective products (Fail) as a result of the test process (103). Similarly, products inputted into the test process at 80 gigabyte are allocated to 80 gigabyte products, 60 gigabyte products and defective products (Fail) as a result of the test process (103).

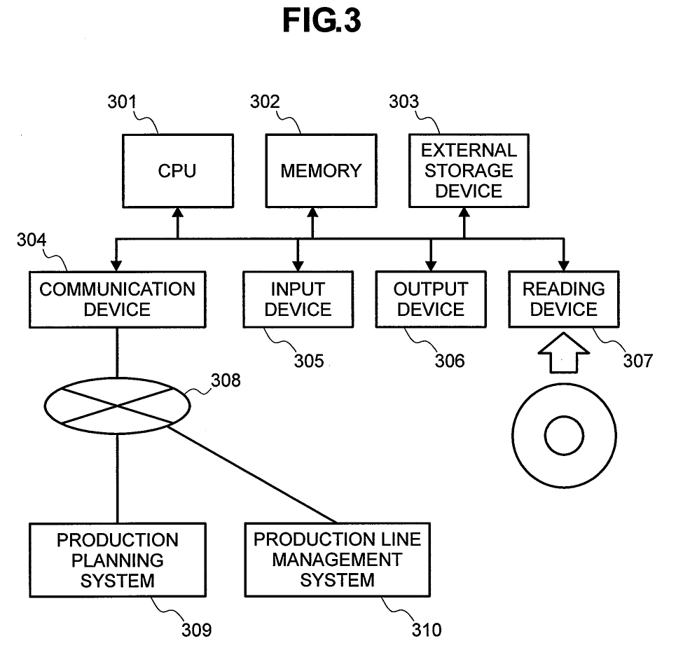

Next, the production instruction system according to the invention can be constructed on a computer system having a common configuration as shown in FIG. 3, which includes a CPU (301), a memory (302), an external storage device (303) such as a hard disk device, a device (307) of reading data from a portable storage medium such as a CD-ROM or a DVD-ROM, an input device (305) such as a keyboard or mouse, an output device (306) such as a CRT or a LCD, a communication device (304) performing communication through a network (308) such as Internet, a bus connecting respective devices and the like, or can be constructed on a network system including plural computer systems. In addition, an external production planning system (309), a production line management system (310) and the production instruction system of the invention are connected through the network (308). The production planning system (309) manages input plan information, for example, weekly. There are some cases in which one production line management system (310) manages production performance information of all production lines and some cases in which plural systems are set for the number of production lines.

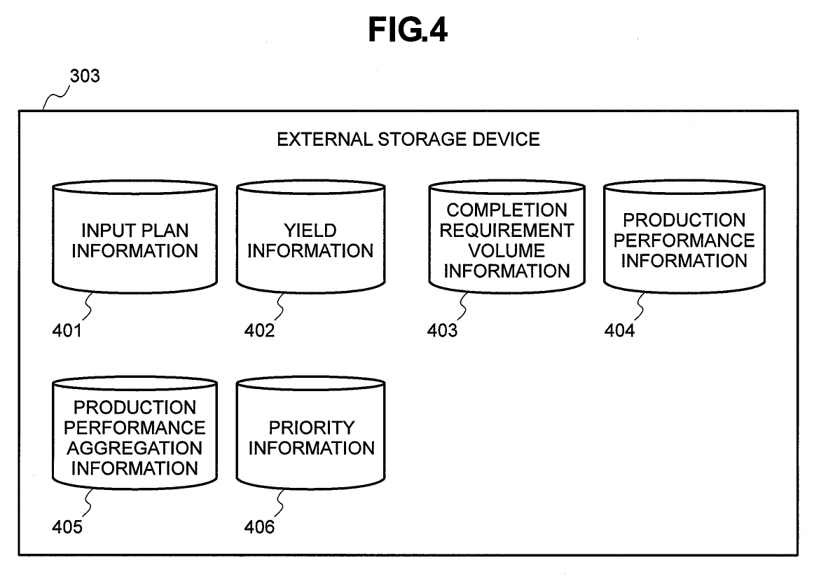

The external storage device (303) of the production instruction system of the invention includes, for example, as shown in FIG. 4, an input plan information (401) registering input plans to respective production processes of each product calculated in the production planning system (309), a yield information (402) indicating information of proportions that products are selected as products having respective standard values or as defective products according to quality of respective products passed through production processes which is created in the production line management system (310), a completion requirement volume information (403) read from the production line management system (310) to be registered therein, a production performance information (404), a production performance aggregation information (405) and a priority information (406).

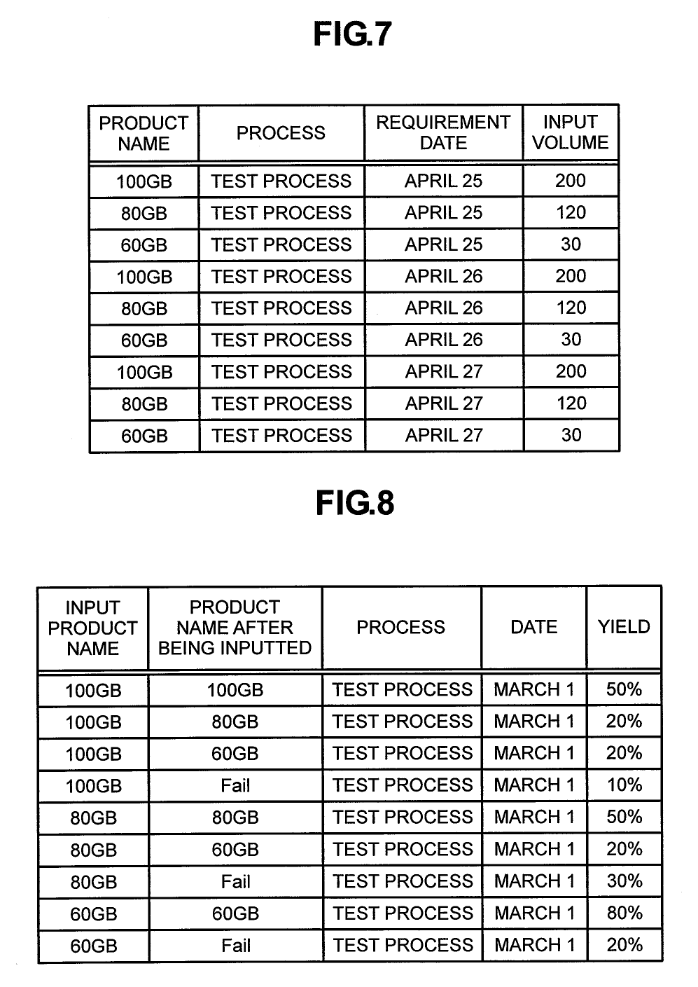

An example of the input plan information (401) is shown in FIG. 7. Respective records registered in the input plan information include a field for registering production numbers which are identification numbers of final assemblies, a field for registering production processes passing until becoming the final assemblies, a field for registering dates when inputted to the production process and a field for registering quantities of products inputted to the production process.

An example of the yield information (402) is shown in FIG. 8. Respective records registered in the yield information include a field for registering production numbers at the time of being inputted to the production process, a field for registering production numbers after passing through the production process, a field for registering production processes, a field for registering dates and a field for registering proportions in which products inputted to the production process becomes after-inputted products after passing through the production process.

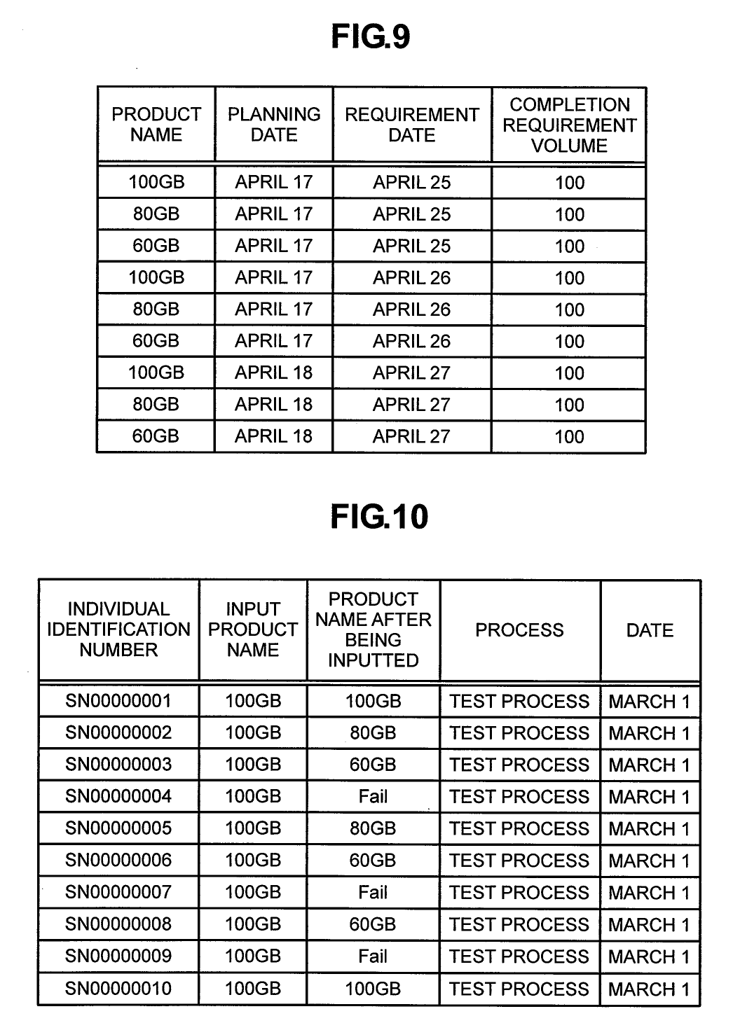

An example of the completion requirement volume information (403) is shown in FIG. 9. Respective records registered in the completion requirement volume information include a field for registering production numbers which are identification numbers of final assemblies, a field for registering planning dates, a field for registering completion requirement date and a field for registering quantities to be shipped until the requirement date.

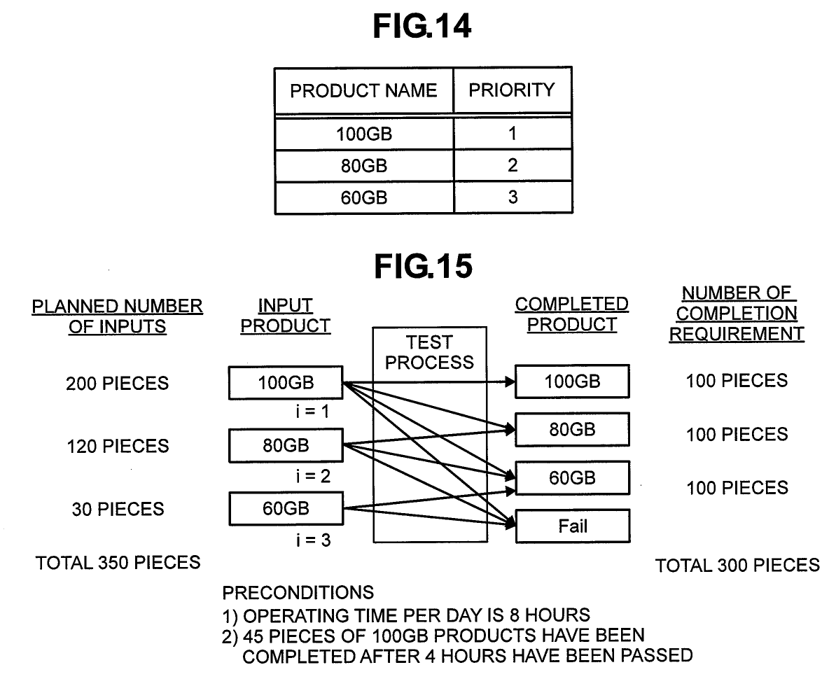

An example of the priority information (406) is shown in FIG. 14. Respective records registered in the priority information include a field for registering production names and a field for registering priority of products.

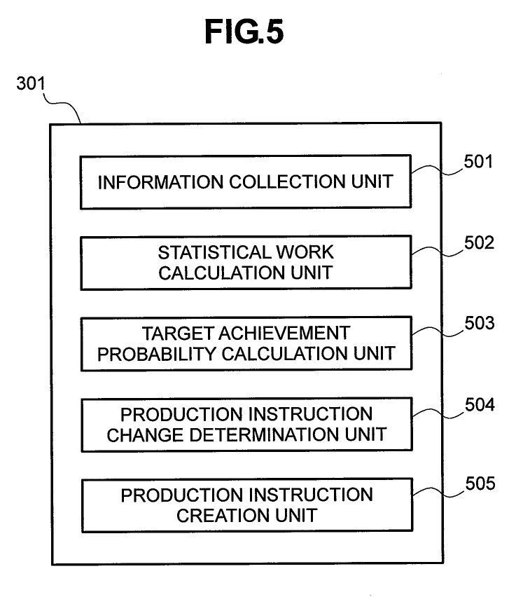

Next, a processing program executed by the CPU (301) of the production instruction system according to the invention will be explained with reference to FIG. 5. The processing program includes an information collection unit (501) collecting the input plan information (401) registering input plans of respective products to respective production processes calculated in the production planning system (309), the yield information (402) created by the production line management system (310), the completion requirement volume information (403) and the production performance information (404), a statistical work calculation unit (502) performing statistical work based on the past production performance by using data collected and registered by the information collection unit (501), a target achievement probability calculation unit (503) calculating a target achievement probability to a final target in the production performance at present time by using data registered by the information collection unit (501) and the result by the statistical work calculation unit (502), a production instruction change determination unit (504) changing a product mix (a product ratio of input volume to the production line) by comparing a result of the target achievement probability calculation unit (503) with a threshold so as to be within the threshold, and a production instruction creation unit (505) creating production instruction information by using a result of the production instruction change determination unit (504).

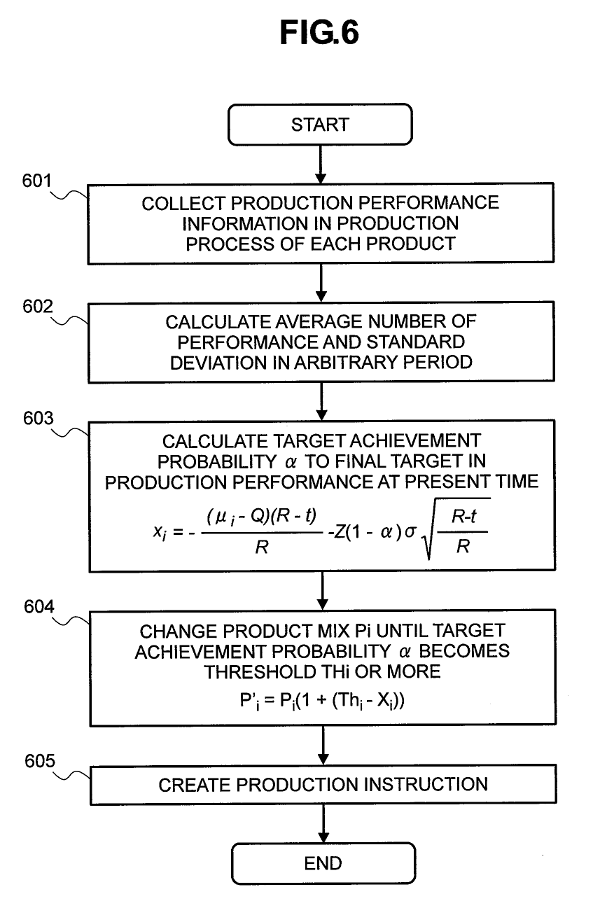

FIG. 6 shows a processing flow of the production instruction system according to the embodiment of the invention. Hereinafter, explanation will be made with reference to the processing flow.

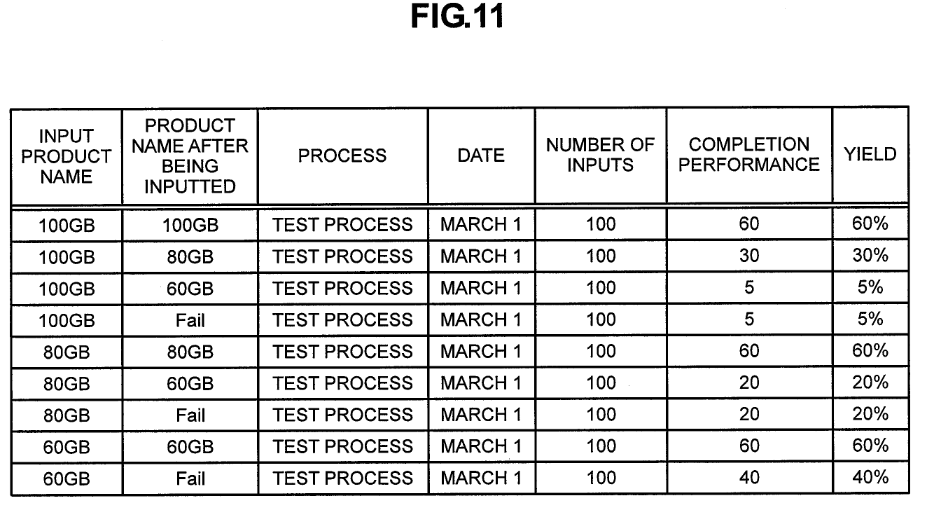

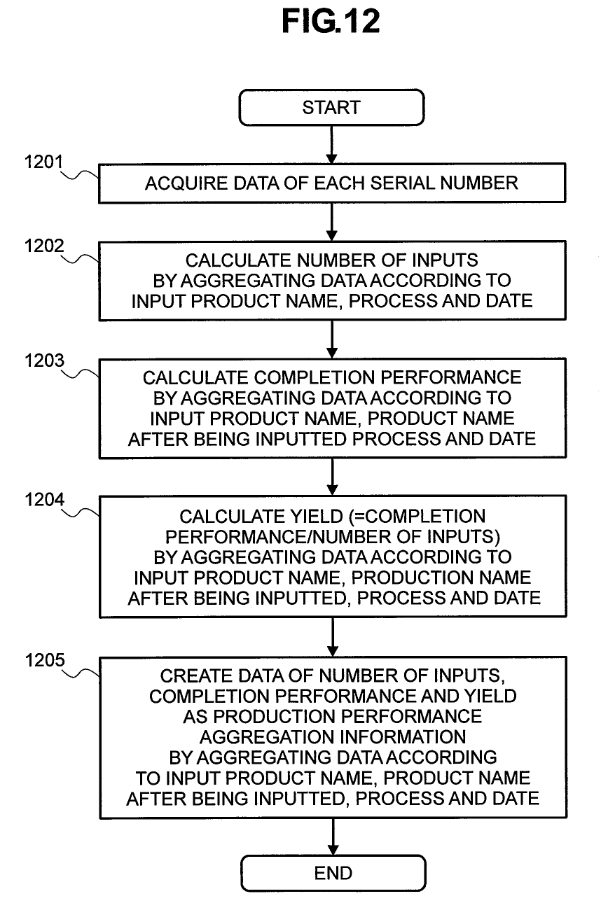

In the invention, production performance information in a production process of each product is collected first (601). The details of processing based on the production performance information are shown in FIG. 12. First, production performance information at each individual identification number is acquired (1201). The individual identification numbers are identification numbers for identifying each product. An example of the product performance information of respective individual identification numbers is shown in FIG. 10. Respective records registered in the production performance information includes individual identification numbers which is a field for identifying products, a field for registering product names when inputted to the production process, a field for registering product names after passing through the production process (in the production process, when performance of the product is evaluated that it does not satisfy the original standard value in design, a product name determined to be produced as another product having a different standard value, or when the product is determined that it satisfies the original standard value in design, the same product name as the one at the time of being inputted to the production process, or when the product does not satisfy a design standard value of any product, Fail indicating a defective product), a field for registering production processes, and a field for registering dates.

Next, the number of inputs is calculated (1202) by aggregating data according to the input product name, the process and the date, targeting the production performance information by each individual identification number. Also, the completion performance is calculated (1203) by aggregating data according to the input product name, the product name after being inputted, the process and the date, targeting the product performance information by each individual identification number. Next, yield (=completion performance/number of inputs) is calculated (1204) by aggregating data according to the input product name, the product name after being inputted, the process and the date, targeting the product performance information by individual identification number unit. Lastly, data of the number of inputs, the completion performance and the yield is created as production performance aggregation information (1205) by aggregating data according to the input product name, the product name after being inputted, the process and the date.

An example of the production performance aggregation information is shown in FIG. 11. Respective records registered in the production performance aggregation information includes a field for registering product names at the time of being inputted to the production process, a field for registering production names after passing through the production process, a field for registering production processes, a field for registering input dates, a field for registering the number of inputs inputted to the production process, a field for registering the number of completion performance to be products after being inputted after passing through the production process and a field for recording yields.

In addition, a corresponding period of the present processing is determined in advance. For example, the corresponding period is determined such as for a month in the past until the present day.

Next, calculation of statistical work is performed (602), which calculates the average number of performance and a standard deviation in an arbitrary period by using the collected performance information. For example, when the corresponding period is “n”, the yield of a product “i” is Yij, the average μi of the yield Yij of the product “i” is shown in a formula 1. The standard deviation of the yield Yij of the product “i” is shown in a formula 2.

$$\begin{matrix}{μ}_{i} = \frac{1}{n} {\sum }_{j = 1}^{n} {Y}_{ij} & [ Formula 1 ] \\ {σ}_{i} = \sqrt{\frac{1}{n} {\sum }_{j = 1}^{n} {( {Y}_{ij} - {μ}_{i} )}^{2}} & [ Formula 2 ]\end{matrix}$$

Next, a target achievement probability α to a final target in the production performance at present time is calculated by the target achievement probability calculation unit based on the information obtained by the information collection unit and the statistical work calculation unit (603). For example, the target achievement probability α satisfies a formula 3.

$${x}_{i} = - \frac{( {μ}_{i} - Q ) ( R - t )}{R} - Z ( 1 - α ) σ \sqrt{\frac{R - t}{R}} \qquad [ Formula 3 ]$$

In the above formula, the difference between the input plan and production performance in a certain point “t” (0=<t=<R) during a certain production period R of a certain product “i” is Xi, the average of the production performance of the certain product “i” is μ, the dispersion is σ, and the completion requirement volume in the production period R is Q. In addition, Z(1−α) indicates a value of an inverse function of the cumulative distribution function in the normal distribution when the target achievement probability is α.

A derivation process of the formula 3 is explained. When the production performance in the production period R is described as the normal distribution NR, the production performance at the certain point “t” can be defined as Nt. Also, the production plan at the certain point “t” can be defined as St, which can be described by a formula 4.

$${S}_{t} = Q \frac{t}{R} \qquad [ Formula 4 ]$$

The difference Xt between the input plan and the production performance in the certain point “t” (0=<t=<R) during the production period R can be described by a formula 5.

$${x}_{t} = Nt - St = Nt - Q \frac{t}{R} \qquad [ Formula 5 ]$$

The average μt and the dispersion at can be defined by a formula 6 and a formula 7 since both of them are the normal distribution.

$$\begin{matrix}{μ}_{t} = ( μ - Q ) \frac{t}{R} & [ Formula 6 ] \\ {σ}_{t} = {σ}^{2} \frac{t}{R} & [ Formula 7 ]\end{matrix}$$

Similarly, the average μt and the dispersion at of the production volume NR−t of residual time R−t can be defined by a formula 8 and a formula 9.

$$\begin{matrix}{μ}_{t} = μ \frac{R - t}{R} & [ Formula 8 ] \\ {σ}_{t} = {σ}^{2} \frac{R - t}{R} & [ Formula 9 ]\end{matrix}$$

According to the above, when the target achievement probability is α, a probability (1−α) that the target is not achieved satisfies a formula 10.

$$\begin{matrix}1 - α = P ( {N}_{R - t} < Q - {n}_{t} ) \\ = P ( {N}_{R - t} < Q \frac{R - t}{R} - x ) \\ = φ [ \frac{( Q - μ ) ( R - t ) / R - x}{σ \sqrt{( R - t ) / R}} ]\end{matrix} \qquad [ Formula 10 ]$$

Φ indicates a value of normal distribution. When the formula 10 is replaced with a value Z which is an inverse function of the cumulative distribution function in the normal distribution, a formula 11 is derived.

$$x = - \frac{( μ - Q ) ( R - t )}{R} - Z ( 1 - α ) σ \sqrt{\frac{R - t}{R}} \qquad [ Formula 11 ]$$

In the above formula, Z(1−α) satisfies a formula 12.

φ(Zα)=α [Formula 12]

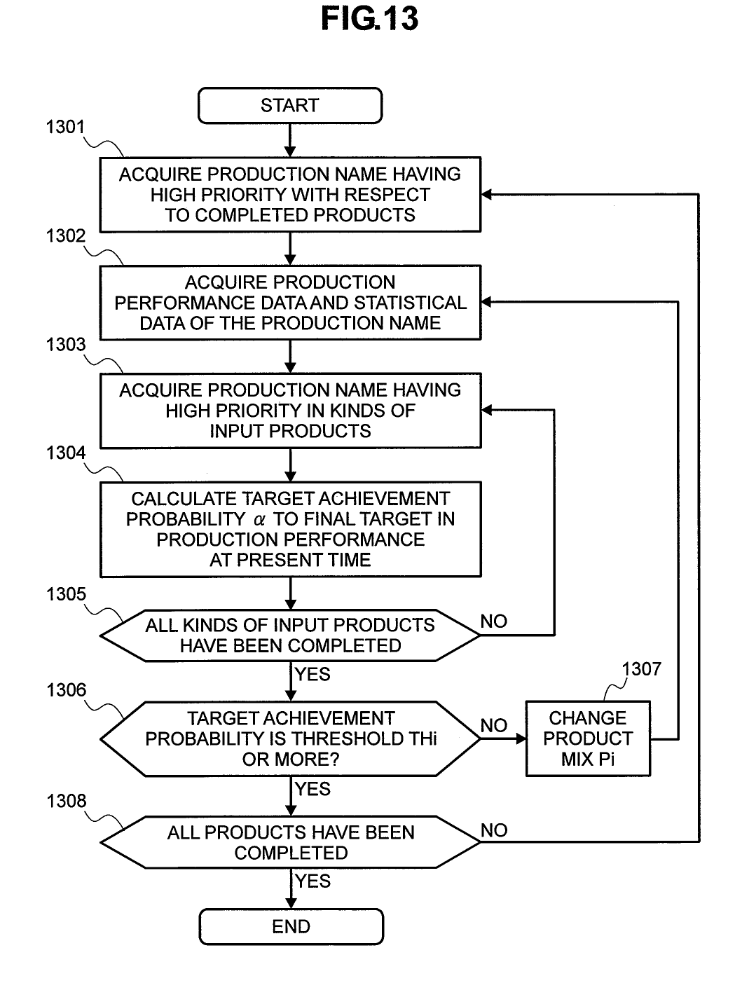

Next, the target achievement probability α calculated in the step (603) in FIG. 6 is compared with a threshold Thi determined according to the product registered in advance (604) Specifically, a processing flow is shown in FIG. 13. In addition, a specific example will be explained with reference to the products and the test process shown in FIG. 2. Also, preconditions are shown in FIG. 15. Three products (100 GB, 80 GB and 60 GB) are inputted into the test process. As a result, three products (100 GB, 80 GB and 60 GB) and defective products (Fail) are obtained as completed products. The numbers of completion requirement for the three products (100 GB, 80 GB and 60 GB) are 100 pieces, 100 pieces, and 100 pieces per day. The planned numbers of inputs for the three products (100 GB, 80 GB and 60 GB) are 200 pieces, 120 pieces and 30 pieces per day. The number of completion requirement and the planned number of inputs have data as shown in FIG. 9, FIG. 7 respectively, and data is acquired from other systems such as the production planning system or the production line management system. Additionally, as preconditions, operating time per day is 8 hours and assume that 45 pieces of products of 100 GB have been completed after four hours have passed since the operation start of a certain day until the present. Data of the completion information in the middle of a day is obtained according to the processing flow of FIG. 12 in the information collection unit in the same manner.

The processing flow of FIG. 13 will be explained. At first, a production name having high priority with respect to the completed products is acquired (1301). An example of priority is shown in FIG. 14. In the example, the lower a value of priority is, the higher the priority of the product is. In this case, the priority of 100 GB is the highest, therefore, 100 GB is subjected to be processed first.

Next, statistical data of the product name is acquired (1302). Specifically, the data will be the yield average value and the yield standard deviation calculated in (602). In this case, the yield average value of 100 GB is 50% and the yield standard deviation is 30%. Next, the product name having high priority in the kinds of input products with respect to the completed products is acquired (1303). For example, when the completed product is 100 GB, the input product is only 100 GB, however, when the completed product is 80 GB, there are two kinds of input products which are 100 GB and 80 GB. In this case, the priority as shown in FIG. 14 is used for the input products, calculating the following steps.

Then, the target achievement probability α to the final target in the production performance until the present time is calculated (1304). The target achievement probability α satisfies the formula 3. In the case of 100 GB, calculation is performed under the condition that a certain product i=1, a certain point t=4 in a production period (operating time per day) R=8. The difference Xi between the input plan and the production performance in the point “t” of the production period R is expressed by the following formula:

$${x}_{i} = \frac{{I}_{i} \cdot ( R - t )}{R} - {C}_{i , t} \qquad [ Formula 13 ]$$

In the above formula, the planned number of inputs of the product “i” per day is Ii, the production performance of the product “i” at the point “t” in the production period R is Ci,t. Also, the average of the production performance of 100 GB is μ=100, the dispersion is σ=30, the completion requirement volume in the production period R=8 is Q=100. The target achievement probability α at this time is 41%.

Next, whether all kinds of input products have been completed is confirmed (1305). In the case of 100 GB, since the kind of the input product is only one, the process ends. In the case that there are two kinds or more of input products as in the case of 80 GB, the process returns to (1303) step, and the product name having the secondarily high priority in the input kinds is acquired, calculating the target achievement probability again (1304).

When all kinds of input products have been completed, whether the target achievement probability is the threshold Thi or more is confirmed (1306). The threshold is usually 50%. In the case that the priority of the product is extremely high and the delivery date is strict, the threshold Thi is increased. In the case of 100 GB, when the threshold Thi is 50%, the target achievement probability αi is 41%, therefore, the product mix Pi will be changed (1307).

When the target achievement probability αi is less than the threshold, the change of the product mix Pi is performed by a formula 14.

P′ᵢ=Pᵢ(1+(Thᵢ−Xᵢ)) [Formula 14]

The product mix Pi is shown by the following formula (formula 15):

$${P}_{i} = \frac{{I}_{i}}{{\sum }_{k = 1}^{n} {I}_{k}} \qquad [ Formula 15 ]$$

In the above formula, the planned number of inputs of the product “i” per day is Ii, the number of products is “n”.

In the case of 100 GB, for example, according to the input plan information of April 25 in FIG. 7, Pi is 0.57, therefore, P′i will be 0.62. According to this, the new number of inputs I′i is calculated by a formula 16.

$${I}_{i}^{′} = {P}_{i}^{′} {\sum }_{k = 1}^{n} {I}_{k} \qquad [ Formula 16 ]$$

In the above, the planned number of inputs of the product “i” is Ii, the number of products is “n”.

As described above, after the product mix P′i is changed, the process proceeds to step (1302), the target achievement probability αi is calculated again, repeating the process until becoming the threshold or more. In the example of 100 GB, the target achievement probability αi calculated again is 49%, therefore, the product mix is changed again. In the third calculation, the probability exceeds 50%, the product mix is fixed here (604).

The above processing is repeated until all products are completed (1308).

Lastly, the product instruction is created based on the changed product mix and the input plan information in the external storage device (303) is updated (605).

According to the processing flow shown above, the production instruction can be created in real time, in which divergence between the planned number of inputs and the number of completion generated by variations of the production volume is prevented to the minimum so as to strictly observe delivery time for customers.

What is claimed is:

1. A production instruction system which creates production instructions of a product in which a characteristic value of each product is liable to vary from a standard value aimed in design due to instability of production processes, comprising;
an information collection unit configured to collect performance information of results selected as a product in accordance with design when each product satisfies an original design standard value, selected as other products having different standard values when each product does not satisfy the original design standard value, or selected as detective products when each product does not satisfy any standard value according to measured characteristic values by measuring characteristic values of each inputted product in a test process in plural production processes;
a statistical work calculation unit configured to calculate the average number of performance and a standard deviation in an arbitrary period by using the collected performance information;
a target achievement probability calculation unit configured to calculate a target achievement probability to a final target in production performance at present time in accordance with information obtained from the information collection unit and the statistical work calculation unit;
a production instruction change determination unit configured to fix the change of product mixes of all products, determining production instruction change by comparing the target achievement probability to the final target calculated in the target achievement probability calculation unit with a threshold set in advance, and repeating processing of changing the product mix until the target achievement probability becomes the threshold or more; and
a production instruction creation unit configured to create production instructions based on the product mix information fixed by the production instruction change determination unit and production plan information.

2. The production instruction system according to claim 1,
wherein a target achievement probability α to the final target in the production performance at present time is represented by the following formula:
$${x}_{i} = - \frac{( {μ}_{i} - Q ) ( R - t )}{R} - Z ( 1 - α ) σ \sqrt{\frac{R - t}{R}}$$
and
wherein the above formula satisfies that, the difference between an input plan and production performance in a certain point “t” (0=<t=<R) during a certain production period R of a certain product “i” is Xi, the average of the production performance of the certain product “i” is μ, the dispersion is σ, and the completion requirement volume in the production period R is Q, and Z(1−α) indicates a value of an inverse function of the cumulative distribution function in the normal distribution when the target achievement probability is α.

3. The production instruction system according to claim 2,
wherein the difference Xi between the input plan and the production performance in the point “t” of the production period R can be found by the following formula:
$${x}_{i} = \frac{{I}_{i} \cdot ( R - t )}{R} - {C}_{i , t}$$
and
wherein, in the above formula, the planned number of inputs of the product “i” per day is Ii, the production performance of the product “i” at the point “t” in the production period R is Ci,t.

4. The production instruction system according to claim 1,
wherein processing of changing a product mix Pi to P′i until the target achievement probability becomes a threshold Thi or more can be found by the following formula:
P′ᵢ=Pᵢ(1+(Thᵢ−Xᵢ)),
wherein the product mix Pi can be found by the following formula:
$${P}_{i} = \frac{{I}_{i}}{{\sum }_{k = 1}^{n} {I}_{k}}$$
and
wherein, in the above formula, the planned number of inputs of the product “i” per day is Ii, the number of products is “n”.

5. The production instruction system according to claim 1,
wherein the new number of inputs I′i created by the production instruction creation unit can be found by the following formula:
$${I}_{i}^{′} = {P}_{i}^{′} {\sum }_{k = 1}^{n} {I}_{k}$$
and
wherein, in the above, the planned number of inputs of the product “i” is Ii, the number of products is “n”.

6. A production instruction method which creates production instructions of a product in which a characteristic value of each product is liable to vary from a standard value aimed in design due to instability of production processes, comprising the steps of:
collecting performance information of results selected as a product in accordance with design when each product satisfies an original design standard value, selected as other products having different standard values when each product does not satisfy the original design standard value, or selected as detective products when each product does not satisfy any standard value according to measured characteristic values by measuring characteristic values of each inputted product in a test process in plural production processes;
calculating the average number of performance and a standard deviation in an arbitrary period by using the collected performance information;
calculating a target achievement probability to a final target in production performance at present time in accordance with information obtained from the information collection step and the statistical work calculation step;
fixing the change of product mixes of all products, determining production instruction change by comparing the target achievement probability to the final target calculated in the target achievement probability calculation step with a threshold set in advance, and repeating processing of changing the product mix until the target achievement probability becomes the threshold or more; and
creating production instructions based on the product mix information fixed by the production instruction change determination step and production plan information.

7. The production instruction method according to claim 6,
wherein a target achievement probability α to the final target in the production performance at present time is represented by the following formula:
$${x}_{i} = - \frac{( {μ}_{i} - Q ) ( R - t )}{R} - Z ( 1 - α ) σ \sqrt{\frac{R - t}{R}}$$
and
wherein the above formula satisfies that, the difference between an input plan and production performance in a certain point “t” (0=<t=<R) during a certain production period R of a certain product “i” is Xi, the average of the production performance of the certain product “i” is μ, the dispersion is σ, and the completion requirement volume in the production period R is Q, and Z(1−α) indicates a value of an inverse function of the cumulative distribution function in the normal distribution when the target achievement probability is α.

8. The production instruction method according to claim 6,
wherein the difference Xi between the input plan and the production performance in the point “t” of the production period R can be found by the following formula:
$${x}_{i} = \frac{{I}_{i} \cdot ( R - t )}{R} - {C}_{i , t}$$
and
wherein, in the above formula, the planned number of inputs of the product “i” per day is Ii, the production performance at the point “t” in the production period R of the product “i” is Ci,t.

9. The production instruction method according to claim 6,
wherein processing of changing a product mix Pi to P′i until the target achievement probability becomes a threshold Thi or more can be found by the following formula:
P′ᵢ=Pᵢ(1+(Thᵢ−Xᵢ)),
wherein the product mix Pi can be found by the following formula:
$${P}_{i} = \frac{{I}_{i}}{{\sum }_{k = 1}^{n} {I}_{k}}$$
and
wherein, in the above formula, the planned number of inputs of the product “i” per day is Ii, the number of products is “n”.

10. The production instruction method according to claim 6,
wherein the new number of inputs I′i created by the production instruction creation step can be found by the following formula:
$${I}_{i}^{′} = {P}_{i}^{′} {\sum }_{k = 1}^{n} {I}_{k}$$
and
wherein, in the above, the planned number of inputs of the product “i” is Ii, the number of products is “n”.
